(19) United States
(12) Patent Application Publication
(10) Pub. No.: US 2010/0151377 A1
(43) Pub. Date: Jun. 17, 2010

(54) TONER AND MANUFACTURING METHOD OF TONER

(75) Inventors: Yasuko UCHINO, Tokyo (JP); Mikihiko SUKENO, Tokyo (JP); Tomomi OSHIBA, Tokyo (JP); Nagayuki UEDA, Tokyo (JP); Makoto KOBAYASHI, Tokyo (JP); Ken OHMURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/635,155

(22) Filed: Dec. 10, 2009

(30) Foreign Application Priority Data
Dec. 17, 2008 (JP) 2008320972

(51) Int. Cl. G03G 9/08

(52) U.S. Cl. 430/110.2; 430/105; 430/137.14

(57) ABSTRACT

Disclosed is a toner, comprising: a noncrystalline polyester resin; a crystalline polyester resin; a release agent; and a coloring agent, wherein the toner has a domain matrix structure in which the matrix comprises the noncrystalline polyester resin and the domain comprises the crystalline polyester resin and the release agent, and wherein the crystalline polyester resin includes within the release agent.

### BACKGROUND OF THE INVENTION

1. Field of the Invention

The present invention relates to a toner and a manufacturing method of the toner.

2. Description of Related Art

An image forming apparatus of an electrophotographic method which has conventionally been used as a copier or a printer at offices and the like, has recently been capable of printing and outputting color images of high image quality with high speed. Such color image forming apparatus provides superiority in producing printed matter such as direct mails, customized catalogs, leaflets and the like, on which variable information is printed. Since the color image forming apparatus does not require a plate, the image forming apparatus has now begun to be widely used as a substitute of an offset printer which is a mainstream in commercial printing. The image color image forming apparatus is also referred to as “a digital printer”.

In order for the image forming apparatus to expand as a substitute technique of the offset printing, there still remains a problem at the time of heating and fixing. For example, sheets for the offset printing are designed so as to have better affinity with water. Accordingly, when an image formed by a toner is heated and fixed on a sheet for the offset printing, moisture is vaporized from the sheet, thus there remained a problem that the sheet was likely to be curled up. In order for the moisture to be prevented from being vaporized as much as possible from the sheet at the time of heating and fixing, a low-temperature fixing technique under a severe condition is demanded. In particular, a technique in which thick sheets with weight which makes the heating and fixing difficult can be subjected to printing without lowering the speed is demanded.

Further, printed matter which is formed with images by a toner is required to have high level of quality. For example, thickness of sheets to be used is different depending on the intended usage of the types of the printed matter, such as a catalog, a leaflet, and the like. However, a toner by which printed matter with high fixing property and high quality can be obtained is demanded, regardless of whether the sheets are thick or thin.

Regarding these problems, attempts to solve the problems in terms of the toner design have been made. Among the attempts, suggestions are made in which an emulsion polymerization condensation method being taken notice of as a toner manufacturing method is applied, thereby the toner is designed so as to deal with the low-temperature fixing (see, for example, Japanese Patent Application Laid-Open Publication Nos. 2007-140478, 2008-40319, and 2008-203779). To put it concretely, a toner manufacturing method is suggested wherein the toner is suitable for the low-temperature fixing, and comprises a core-shell structure which includes a core using a binder-resin having a low glass transition temperature, and a shell using a binder-resin having a relatively high glass transition temperature. Specifically, Japanese Patent Application Laid-Open Publication No. 2008-40319 describes a toner manufacturing method to realize the low-temperature fixing property, wherein the toner has a core-shell structure which comprises a core including a crystalline and noncrystalline polyester resin, and a shell including a noncrystalline polyester resin.

However, in the toner described in Japanese Patent Application Laid-Open Publication No. 2008-40319, the binder-resin is in a state of a matrix, and the crystalline polyester resin and a release agent independently form a domain respectively in the toner particles. Thus, the above mentioned toner has a structure in which an area in the toner particles where a coloring agent can be evenly dispersed is limited due to the existence of these domains. Further, a transmitted light is scattered from a surface boundary between the domain of the crystalline polyester resin and the domain of the noncrystalline polyester resin, or from a surface boundary between the domain of the release agent and the domain of the noncrystalline polyester resin, which results in less transparency in the images. Moreover, the domain of the crystalline polyester resin or the domain of the release agent, and the noncrystalline resin are respectively likely to escape from the toner particles, thus the filming occurs in the photo conductor of the image forming apparatus, which brings about the problem that an image defect is generated.

As a measure to prevent the filming of a photo conductor, a technique is also disclosed to form a structure in which the crystalline polyester resin is in contact with the release agent. However, this technique is not sophisticated enough to provide stability of the toner production.

### SUMMARY OF THE INVENTION

The objects of the present invention include, improving the low-temperature fixing property and the fixing intensity of a toner, and providing a toner with superiority in filming-resistant property and stability in production thereof.

To achieve the above objects, a toner reflecting one aspect of the present invention, comprises:

a noncrystalline polyester resin;

a crystalline polyester resin;

a release agent; and

a coloring agent,

wherein the toner has a domain matrix structure in which the matrix comprises the noncrystalline polyester resin and the domain comprises the crystalline polyester resin and the release agent,

and wherein the crystalline polyester resin includes within the release agent.

To achieve the above objects, a manufacturing method of a toner reflecting another aspect of the present invention, comprises:

aggregating at least a noncrystalline polyester resin, a coloring agent, and a crystalline polyester resin including within a release agent in an aqueous medium.

### DETAILED DESCRIPTION OF THE PREFERRED EMBODIMENTS

Hereinbelow, a toner and a manufacturing method of the toner according to an embodiment of the present invention are described.

### [Toner]

The toner according to the embodiment of the present invention comprises, at least: a noncrystalline polyester resin, a crystalline polyester resin, a release agent, and a coloring agent. The toner has a domain matrix structure in which at least the noncrystalline polyester resin forms a matrix, and at least the crystalline polyester resin and the release agent forms a domain. The crystalline polyester resin in the domain may include within the release agent in the matrix comprising the noncrystalline polyester resin.

1. Noncrystalline Polyester Resin

The toner according to the embodiment of the present invention comprises the noncrystalline polyester resin as a binder-resin. By the inclusion of the noncrystalline polyester resin, a dispersing property of the coloring agent in the toner particles, and the filming-resistant property of the toner can be improved. Incidentally, the noncrystalline polyester resin is referred to as a polyester resin which does not show a heat absorption peak in a heat absorption amount variation measured by a differential scanning calorimetry (DSC).

The noncrystalline polyester resin which is applicable to the toner according to the embodiment of the present invention is not particularly limited as long as it is noncrystalline. A known polyester resin can also be applied.

For example, the noncrystalline polyester resin can be obtained by synthesizing a known polycarboxylic acid and a polyalcohol. Further, either a commercially available noncrystalline polyester resin or a noncrystalline polyester resin which is obtained by a suitable synthesis may be applied.

The toner according to the embodiment of the present invention may have a core-shell structure which comprises a core and a shell. In this case, the core is made to have a domain matrix structure in which the domain comprises the crystalline polyester resin which includes within the release agent in the matrix comprising the noncrystalline polyester resin.

In the case where the toner according to the embodiment of the present invention has the core-shell structure, the noncrystalline polyester resin to be used for the core may either be of only 1 type, or a combination of 2 or more types of the noncrystalline polyester resin. Further, it is preferable that the noncrystalline polyester resin to be used for the shell be of the same type as that used for the core, however, a different type of the noncrystalline polyester resin may also be applicable to the shell.

As the polyalcohol component comprised by the noncrystalline polyester resin, a dihydric alcohol such as the followings may be cited: for example, ethylene glycol; propylene glycol; 1,4-butanediol; 2,3-butanediol; diethylene glycol; triethylene glycol; 1,5-pentanediol; 1,6-hexanediol; neopentyl glycol; 1,4-cyclohexandimethanol; dipropylene glycol; polyethylene glycol; polypropylene glycol; bisphenol A; and hydrogenated bisphenol A. Further, the followings may be cited as a trihydric or higher alcohol: for example, glycerin; sorbitol; 1,4-sorbitan; and trimethylolpropane.

As a polycarboxylic acid component comprised by the noncrystalline polyester resin, an aliphatic dicarboxylic acid and an aromatic dicarboxylic acid may be cited. As the aliphatic dicarboxylic acid, the followings may be cited: for example, oxalic acid; succinic acid; glutaric acid; adipic acid; speric acid; azelaic acid; sebacic acid; 1,9-nonanedicarboxylic acid; 1,10-decanedicarboxylic acid; 1,12-dodecanedicarboxylic acid; 1,14-tetradecanedicarboxylic acid; and 1,18-octadecanedicarboxylic acid. As the aromatic dicarboxylic acid, the followings may be cited: for example, phthalic acid; isophthalic acid; terephthalic acid; naphthalene-2,6-dicarboxylic acid; malonic acid; and mesaconic acid. Further, a diacid salt or an acid anhydride of these dicarboxylic acids, or a derivative such as lower alkyl ester may also be used.

A trihydric or higher carboxylic acid may also be used. As the trihydric or higher carboxylic acid, 1,2,4-benzenetricarboxylic acid; 1,2,5-benzenetricarboxylic acid; 1,2,4-naphthalenetricarboxylic acid; and an acid anhydride of these tricarboxylic acids, or a lower alkyl ester may also be used. Only 1 type of these may be used, or alternatively, 2 or more types of these may be used in combination.

Further, it is preferable that the dicarboxylic acid component comprised by the noncrystalline polyester resin include a dicarboxylic acid component having sulfonic acid group, other than the above described aliphatic dicarboxylic acid and the aromatic dicarboxylic acid. The dicarboxylic acid having sulfonic acid group is effective in that it contributes to the improvement of the dispersing property of the coloring agents, such as a pigment. Further, when resin particles are performed with an emulsification or a suspension dispersion into an aqueous medium, thereby resin particle dispersed liquid is produced, the emulsification or the suspension dispersion can be performed without using a surface activating agent, because the dicarboxylic acid component contains sulfonic acid group.

The weight-average molecular weight of the noncrystalline polyester resin which is soluble in tetrahydrofuran (THF) preferably ranges in 10000-60000. Further, the weight-average molecular weight preferably ranges in 12000-20000, in terms of improving the low-temperature fixing property. Here, the weight-average molecular weight is referred to as the one measured by a gel permeation chromatography (GPC). The specific apparatus conditions are described below. Incidentally, the measurement sample is agitated and dissolved in tetrahydrofuran of 40° C. until its solution is visually confirmed.

GPC apparatus: HLC-8220GPC (manufactured by Tosoh Corporation)

column: TSKge1G2000HXL (internal diameter 7.8 mm×30 cm) 3 columns (manufactured by Tosoh Corporation)

column temperature: 40° C.

solvent: tetrahydrofuran

flow rate: 1.0 ml/minute

concentration of sample: 0.1% (v/w)

injection amount of sample: 100 μl

detector: refraction index detector (RI detector)

calibration curve: standard polystyrene, n-hexylbenzene

The glass transition temperature of the noncrystalline polyester resin is preferably 48-63° C., and more preferably 50-58° C.

The mol proportion of the crystalline polyester resin and of the noncrystalline polyester resin in the toner (the crystalline polyester resin:the noncrystalline polyester resin) preferably ranges in approximately 2:98 to 60:40, in terms of obtaining the fixing property, and more preferably ranges in 5:95 to 50:50.

The manufacturing method of the above described noncrystalline polyester resin is not particularly limited, and may be performed by a known polyester resin polymerization method in which the acid component and the alcohol component are reacted with each other. To be more specific, the manufacturing methods thereof, such as a direct polycondensation, a transesterification method, and the like, can be selected to be performed according to the type of the monomer. Further, the mol proportion at the time when the acid component and the alcohol component are reacted is not always the same, depending on the reaction condition, and the like, however, the mol proportion (the acid component:the alcohol component) is normally 1:1.

When the noncrystalline polyester resin is manufactured, the polymerization temperature preferably ranges in 180-230° C. Further, it is preferable that the pressure in the reaction system be reduced, and the reaction be performed in a state where water and alcohol generated at the time of the polymerization are removed from the reaction system, as necessary. Further, when the monomer does not dissolve nor does it show compatibilization under the reaction temperature, a high-boiling point solvent may be added as a solubilization agent, thereby the monomer can be dissolved. Incidentally, when the polymerization reaction is performed, it is preferable to perform the reaction in a state where the solubilization agent is distilled away. Further, when an incompatible monomer exists when a copolymerization is being performed, it is preferable that the incompatible monomer and acid or alcohol to be reacted with the incompatible monomer be previously reacted, and subsequently the reacted substance be performed with the polymerization with the main component.

Further, when the noncrystalline polyester resin is manufactured, it is preferable to perform the polymerization reaction with a catalyst being added. As an applicable catalyst, for example, stannum compounds, zirconium compounds, and germanium compounds may be cited. To be more specific, the followings may be cited: tetraphenyltin; dibutyltin dichloride; dibutyltin oxide; diphenyltin oxide; zirconium tetra butoxide; zirconium naphthenate; zirconyl carbonate; zirconyl acetate; zirconyl stearate; zirconyl octylate; germanium oxide; triphenyl phosphate; tris (2,4-di-t-butylphenyl) phosphate; ethyltriphenyl phosphonium bromide; triethylamine; and triphenylamine. Further, in terms of reducing the discharge amount of carbon dioxide gas which is generated when the noncrystalline polyester resin is manufactured in a state where the polymerization temperature is lowered, rare-earth metal and Lewis acid such as dodecylbenzenesulfonic acid may also be used.

2. Crystalline Polyester Resin

The toner according to the embodiment of the present invention comprises the crystalline polyester resin as a fixing agent. In the embodiment of the present invention, the crystalline polyester resin is referred to as a polyester resin which shows a clear heat absorption peak when measured by the differential scanning calorimetry (DSC). The low-temperature fixing property can be realized by the inclusion of the crystalline polyester resin. Incidentally, when the toner is formed to have a core-shell structure, it is preferable that the crystalline polyester resin be included in the core.

The crystalline polyester resin is not particularly limited as long as it is a polyester resin which shows the above described heat absorption peak. For example, in a case where a polymer having a structure in which the crystalline polyester resin principal chain is performed with copolymerization with other components exists, the polymer may also be included as the crystalline polyester resin according to the embodiment of the present invention, as long as the resin comprising this polymer shows the heat absorption peak.

As the acid component comprised by the crystalline polyester resin, various dicarboxylic acid may be cited. Among those, in terms of covering or including within the release agent, and also preventing the acid component from being released from the noncrystalline polyester resin which is to form the matrix, the acid component is preferably aliphatic dicarboxylic acid, and the acid component is preferably linear aliphatic dicarboxylic acid in particular.

As the aliphatic dicarboxylic acid comprised by the crystalline polyester resin applied in the embodiment of the present invention, the followings may be cited. That is: for example, oxalic acid; malonic acid; succinic acid; glutaric acid; adipic acid; pimelic acid; suberic acid; azelaic acid; sebacic acid; 1,9-nonanedicarboxylic acid; 1,10-decanedicarboxylic acid; 1,11-undecanedicarboxylic acid; 1,12-dodecanedicarboxylic acid; 1,13-tridecanedicarboxylic acid; 1,14-tetradecanedicarboxylic acid; 1,16-hexadecanedicarboxylic acid; and 1,18-octadecanedicarboxylic acid. Further, lower alkyl ester and an acid anhydride of these aliphatic dicarboxylic acids may also be used. Among these aliphatic dicarboxylic acids, adipic acid; fumaric acid; succinic acid; and dodecenylsuccinic acid are preferable in terms of the low-temperature fixing.

Further, it is also possible to produce the crystalline polyester by adding aromatic dicarboxylic acid to aliphatic dicarboxylic acid. The applicable aromatic dicarboxylic acid may preferably be terephthalic acid; isophthalic acid; and orthophthalic acid. The additive amount of the aromatic dicarboxylic acid is preferably 20 composition mol % or less, more preferably 10 composition mol % or less, and further preferably 5 composition mol % or less. The additive amount of the aromatic dicarboxylic acid is controlled to be 20 composition mol % or less, thereby the emulsion at the time of the manufacturing can be reliably performed, and the crystalline of the polyester resin can be ensured. Thus, this is preferable in obtaining the image gloss property which is characteristic owing to the crystalline polyester resin. Further, this is also preferable in that one is saved from concerning that the image saving property be reduced due to the lowered melting point.

As the alcohol compounds which configure the alcohol component in the crystalline polyester resin, aliphatic diol is preferable, and among the aliphatic diol, linear aliphatic diol in which the number of the carbon atoms configuring the principle chain ranges in 2-22 is more preferable. Further, in terms of easy availability, reliable realization of the low-temperature fixing property, and obtaining images with high gloss property, the linear aliphatic diol in which the number of the carbon atoms configuring the principle chain ranges in 2-14 is especially preferable. Further, branched aliphatic diol may also be applied, however, in this case, it is preferable to make the proportion of the linear aliphatic diol be relatively high in order to ensure the crystalline of the polyester resin. By making the proportion of the linear aliphatic dial be relatively high, the crystalline of the polyester resin can be ensured, and the image saving property is not reduced due to the lowered melting point. Further, it is also effective in obtaining a toner blocking-resistant property and stabilizing the lower-temperature fixing property.

By making the number of the carbon atoms configuring the principle chain of the aliphatic diol range in 2-22, polyester resin having a melting point in which the low-temperature fixing may be interfered will not be formed, even with the combination usage of the aromatic dicarboxylic acid. Thus, the aliphatic diol can be sufficiently dissolved at the time of the low-temperature fixing. Further, toner images having high gloss property can be formed. Here, the toner image is referred to as an image formed by using a toner.

As the aliphatic diol, the followings can be cited, although not particularly limited thereto. That is: ethylene glycol; 1,3-propanediol; 1,4-butanediol; 1,5-pentanediol; 1,6-hexanediol; 1,7-heptanediol; 1,8-octanediol; 1,9-nonanediol; 1,10-decanediol; 1,11-undecanediol; 1,12-dodecanediol; 1,13-tridecanediol; 1,14-tetradecanediol; 1,18-octadecanediol; and 1,20-eicosanediol. Among the cited aliphatic diol, ethylene glycol; 1,4-butanediol; 1,6-hexanediol; 1,9-nonanediol; and 1,10-decanediol are preferable.

As to the alcohol component configuring the crystalline polyester resin, the contained amount of the aliphatic diol component is preferably 80 composition mol % or more, and more preferably 90 composition mol % or more. The alcohol component may contain dial component other than the aliphatic diol component as necessary. By making the contained amount of the aliphatic diol component be 80 composition mol % or more, it is effective in realizing the crystalline of the polyester resin, the high gloss property of the toner images to be formed, and the low-temperature fixing property.

Other alcohol components which can be contained as necessary may include, for example, diol component having double bond, diol component having sulfonic acid group, and the like. As the diol component having double bond, for example, 2-butene-1,4-diol; 3-butene-1,6-diol; and 4-butene-1,8-diol may be cited. The contained amount of the dial component having double bond with respect to the entire acid component is preferably 20 composition mol % or less, and more preferably ranges in 2-10 composition mol %. By making the contained amount of the diol component having double bond be 20 composition mol % or less, the crystalline of the polyester resin to be formed can be easily maintained. Further, the melting point of the formed polyester resin is less likely to be lowered so much, thereby the filming is prevented from being generated.

The melting point of the crystalline polyester resin used in the embodiment of the present invention is preferably in the range of 60-98° C., and more preferably in the range of 70-92° C. By controlling the melting point of the crystalline polyester resin to be in the range of 60-98° C., the generation of the filming and the reduction of the saving property of the toner images having been performed with the fixing processing, which are caused by the melting point of the polyester resin, can be avoided. Further, rough images and gloss reduction due to the melting point being too high can be prevented.

The weight-average molecular weight of the crystalline polyester resin preferably ranges in 10000-20000, in terms of ensuring the filming-resistant property, and more preferably ranges in 15000-19000. Here, the weight-average molecular weight is measured by the gel permeation chromatography (GPC) in the same manner as one of the above mentioned noncrystalline polyester resin.

The contained amount of the crystalline polyester resin in the entire toner is preferably in the range of 1-40% by mass, and more preferably in the range of 5-30% by mass. Due to the contained amount of the crystalline polyester resin being in the range of 1-40% by mass, the desired low-temperature fixing property can be obtained, and the dispersing property of the coloring agent is not interfered. Further, the toner fracture caused by the crystalline polyester resin, and the filming can be prevented from being generated.

3. Release Agent

The release agent used in the embodiment of the present invention is not particularly limited, and a known release agent may be applied. To put it concretely, the followings may be cited: low-molecular weight polyolefin group such as polyethylene, polypropylene, polybutene, and the like; plant system wax such as synthesized ester wax, carnauba wax, rice wax, candelilla wax, tree wax, jojoba oil, and the like; mineral or oil system wax such as montan wax; paraffin wax; microcrystalline wax; Fischer-Tropsch wax, and the like; and modified substances thereof.

Among the above cited release agents, the synthesized ester wax having a melting point of 70-95° C. is particularly preferably applied, in terms of preventing the filming. As the synthesized ester wax, for example, behenyl behenate; pentaerythritol tetrabehenate; and tribehenyl citrate may be cited. Further, the synthesized ester wax such as behenyl behenate; pentaerythritol tetrabehenate; and tribehenyl citrate, and paraffin wax having the melting point of 75-100° C. may be used in combination, thereby the gloss property of the toner image and the filming-resistant property can both be improved.

Among the paraffin wax, the offset property in the high-temperature region can be improved regardless of the processing speed ranging from the low-speed region to the high-speed region, when the Fischer-Tropsch wax having the melting point of 75-100° C. is used. In addition, an image forming apparatus in which a cleaning blade functions as a cleaning section can provide a favorable blade cleaning performance.

The contained amount of the release agent in the toner is preferably 5-20% by mass, and more preferably 7-13% by mass. An offset may be generated in the high-temperature region when the contained amount is less than 5% by mass, and the release agent is less likely to be introduced inside the toner when the contained amount is more than 20% by mass. The release agent floating from the toner particles and the one which has not been introduced into the toner particles are likely to be attached to the toner surface, thereby there is a possibility that the floating release agent and the attached release agent may decrease the filming property.

4. Coloring Agent

As the coloring agent, a known coloring agent such as carbon black, a magnetic substance, a dye compound, a pigment, and the like, may arbitrarily be used.

As a black coloring agent, the followings may be used: carbon black such as furnace black, channel black, acetylene black, thermal black, lamp black, and the like; and magnetic powder such as magnetite, ferrite, and the like.

As a colored coloring agent, the ones of magenta (or red), yellow (or orange), cyan (or green), and the like can be used, and known pigments and dye compounds can also be applied. As the magenta coloring agent, pigments such as C.I. pigment red 5, said 48:1, said 53:1, said 57:1, said 122, said 139, said 144, said 149, said 166, said 177, said 178, said 222, and the like; and dye compounds such as C.I. solvent red 1, said 49, said 52, said 58, said 68, said 11, said 122, and the like can be cited. As the yellow coloring agent, pigments such as C.I. pigment yellow 14, said 17, said 74, said 93, said 94, said 138, said 155, said 180, said 185, C.I. pigment orange 31, said 43, and the like; and dye compounds such as C.I. solvent yellow 19, said 44, said 77, said 79, said 81, said 82, said 93, said 98, said 103, said 104, said 112, said 162, and the like can be cited. As the cyan coloring agent, pigments such as C.I. pigment blue 15:3, said 60, C.I. pigment green 7, and the like; and dye compounds such as C.I. solvent blue 25, said 36, said 69, said 70, said 93, said 95, and the like can be cited. Further, the above cited may also be combined.

5. Others

As necessary, an electric charge control agent, an outer additive agent, and the like, may be used for the toner according to the embodiment of the present invention.

As the electric charge control agent, the followings may be cited: nigrosine system dye compound; metallic salt of naphthene acid or higher fatty acid; alkoxylated amine; fourth class ammonium chloride; azo-system metal complex; salicylic metallic salt; metal complex thereof, and the like. The contained metal includes Al, B, Ti, Fe, Co, Ni, and the like. A metal complex compound of benzyl acid derivative is particularly preferable as the electric charge control agent.

As the outer additive agent, it is particularly preferable to add cerium oxide particles or higher alcohol particles having the number of carbon atoms in the range of 20-50, other than a known hydrophobic silica and a hydrophobic metallic oxide, in terms of the filming-resistant property. When the cerium oxide particles are added, using the ones having an average particle diameter in the range of 150-800 nm each is preferable, in terms of improving the filming-resistant property, and using the ones having the average particle diameter in the range of 250-700 nm each is more preferable. Further, the additive amount of the cerium oxide particles with respect to the toner is preferably 0.5-3.5% by mass. By making the additive amount be in the range of 0.5-3.5% by mass, preferable cleaning property can be maintained, thereby the effect of the filming-resistant property can be stably obtained. Further, in a case where the additive amount is too much, the adhesion force of the molten toner particles at the time of heating and fixing is suppressed, thereby the fixing intensity may be reduced. However, the fixing intensity can be prevented from being reduced by making the additive amount be in the above mentioned range.

When higher alcohol particles having the number of carbon atoms in the range of 20-50 are added, alcohol particles having different number of carbon atoms may be included to some extent. However, it is preferable that the peak of the number distribution of the carbon atoms in the alcohol particles be in the range of 20-45. Further, the linear component of the above mentioned higher alcohol particles is preferably in the range of 75-980. Moreover, the median diameter of the above mentioned higher alcohol per each particle is preferably not less than 200 nm and not more than 800 nm, in terms of the filming-resistant property.

[Manufacturing Method of the Toner]

The manufacturing method of the toner according to the embodiment of the present invention comprises a step of combining at least the noncrystalline polyester resin, the coloring agent, and the crystalline polyester resin which may include within the release agent, in an aqueous medium.

Hereinbelow, an example of the manufacturing method of the toner is described.

1. Preparation Steps of Raw Material Dispersion Liquid

1-1. Preparation Steps of Dispersion Liquid of the Noncrystalline Polyester Resin

The noncrystalline polyester resin is added into an aqueous medium with an ionic surface activating agent or a nonionic surface activating agent, and is heated in a temperature which is the same or higher than the melting point of the noncrystalline polyester resin. A strong shearing force is given to the heated compound liquid by using a homogenizer or a pressure discharge-type dispersion machine, thereby the dispersion liquid of the noncrystalline polyester resin is prepared.

As another method, after the noncrystalline polyester resin is dissolved in a solvent, the compound liquid is performed with dispersion and emulsification by using a homogenizer, and the like, in an aqueous medium which is added with an ionic surface activating agent, and performed with solvent removing processing, thereby the dispersion liquid of the noncrystalline polyester resin can also be prepared. Alternatively, after the noncrystalline polyester resin is dissolved in a solvent, the compound liquid may be performed with neutralization, and be added with water while being agitated so as to be performed with phase inversion, thereby phase inversion emulsification processing to remove the solvent is performed, thus the dispersion liquid can also be prepared.

The median diameter on a volumetric basis of the noncrystalline polyester resin particles and the later described crystalline polyester resin particles in the dispersion liquid is preferably 1 μm or less, and more preferably 0.02-0.5 μm. By making the median diameter on a volumetric basis of the noncrystalline and crystalline polyester resin particles be in this range, the particle diameter distribution and the shape distribution of the finally obtained toner can be sharpened, and released particles can be prevented from being generated from the toner particles. As a result, effects can be obtained in that the dispersion of the inner additive agent, such as the coloring agent, and the like, in the toner becomes favorable, and unevenness of the toner performance and production stability can be reduced.

The median diameter on the above mentioned volumetric basis (D50) is a value which is obtained by a measurement performed by dynamic light scattering method using “Microtrac UPA-150” (manufactured by Nikkiso Co. Ltd.). First, several drops of the dispersion liquid of the polyester resin particles, which is the measurement object, are dropped in a graduated cylinder of 50 ml, and are added with 25 ml of purified water. This solution is dispersed for three minutes by an ultrasonic washing machine “US-1” (manufactured by “as one”), and the sample for the measurement is made. 3 ml of the made sample for the measurement is injected in the cell of the “Microtrac UPA-150”, and the value of the Sample Loading is confirmed to be in the range of 0.1-100. Further, the measurement is performed under the following conditions (1) and (2).

(1) Measurement Condition

Transparency: Yes

Refractive Index: 1.59

Particle Density (specific gravity of particles): 1.05 μm/cm³

Spherical Particles: Yes

(2) Solvent Condition

Refractive Index Yes

Viscosity: High(temp) 0.797×10-3 Pa·S
Low(temp) 1.002×10-3 Pa·S

1-2. Preparation of Dispersion Liquid of the Crystalline Polyester Resin and the Release Agent

The crystalline polyester resin and the release agent are dispersed in water with an ionic surface activating agent or a nonionic surface activating agent, and are heated to a temperature which is the same or higher than the melting point of the crystalline polyester resin and the release agent. Here, the compound liquid is preferably heated to a temperature which is not lower than the melting point of at least either one of the crystalline polyester resin and the release agent. A strong shearing force is given to the heated compound liquid by using a homogenizer or a pressure discharge-type dispersion machine, and the like, and is performed with dispersion processing, thereby the dispersion liquid of the crystalline polyester resin including within the release agent is prepared. The particles in this dispersion liquid are in a state where the release agent is covered with the crystalline polyester resin.

In this occasion, it is preferable that the crystalline polyester resin and the release agent are dispersed in an aqueous medium in which the surface activating agent concentration is not higher than the critical micelle concentration (CMC), in terms of making the crystalline polyester resin include the release agent. The ester group concentration of the crystalline polyester resin is higher than that of the release agent, thus it becomes easy for the crystalline polyester resin to be arranged outside of the micelle.

Here, the crystalline polyester resin including within the release agent is referred to as the crystalline polyester resin substantially covering the surface of the release agent, that is to say, 100% of the surface of the release agent being covered with the crystalline polyester resin.

The release agent preferably exists in the crystalline polyester resin phase as a single particle, however, the release agent may exist in a state of a plurality of domains in the crystalline polyester resin. The horizontal Feret's diameter (which is the median diameter with a standard of the number of particles at the time of the manufacturing) of the domain of the release agent preferably ranges in 0.2-1.0 μm, and more preferably ranges in 0.3-0.8 μm. The horizontal Feret's diameter of a particle which is formed by the crystalline polyester resin including within the release agent, is preferably in the range of 0.3-1.5 μm, in terms of ensuring the filming-resistant property.

The median diameter on a volumetric basis of the crystalline polyester resin including within the release agent, contained in the obtained dispersion liquid, is 50 nm-1 μm. The median diameter on a volumetric basis of the crystalline polyester resin including within the release agent preferably ranges in 50 nm to 1 μm, and more preferably ranges in 100-500 nm. By making the median diameter be in this range, it becomes easier for the release agent component to be introduced into the toner, and the dispersion state of the release agent in the toner becomes favorable. Incidentally, the dispersion liquid of the release agent and the crystalline polyester resin may respectively be prepared separately, and the dispersion liquid of the release agent and various dispersion liquids of the crystalline polyester resin, the coloring agent, and the like, may be added and combined either at the same time or separately in a multiple stages, in the later described aggregation steps.

1-3. Preparation Steps of Dispersion Liquid of the Coloring Agent

The aqueous medium which is represented by an aqueous solution of an ionic activating agent or a nonionic activating agent is added with a known coloring agent and is performed with dispersion processing by a dispersion machine, thereby the dispersion liquid of the coloring agent in which the coloring agent is dispersed into fine particles is prepared. The dispersion processing of the coloring agent is performed in the aqueous medium in a state where the surface activating agent concentration is not lower than the critical micelle concentration (CMC). The dispersion machine used in the dispersion processing is preferably a pressurization dispersion machine, such as a supersonic wave dispersion machine; a mechanical homogenizer; Manton-Gaulin; a pressure type homogenizer, and a medium type dispersion machine, such as a sand grinder; Getzman mill; and a diamond fine mill, although the dispersion machine is not particularly limited.

The median diameter on a volumetric basis of the coloring agent particles contained in the dispersion liquid is preferably in the range of 40-200 nm.

2. Aggregation Steps and Aggregation Stopping Steps

The prepared noncrystalline polyester resin dispersion liquid, the coloring agent dispersion liquid, and the dispersion liquid of the crystalline polyester resin including within the release agent, in addition to other inner additive agent component such as a surplus control agent, and an electric charge control agent, as necessary, are combined so that the combined dispersion liquid is obtained, thus an aggregation liquid is added thereto. After the aggregation agent is added, the compound liquid is heated at a temperature which is approximate to the glass transition temperature of the binder-resin such as the noncrystalline polyester resin. Thereby, each of the component particles of the noncrystalline polyester resin particles, the coloring agent particles, the crystalline polyester resin particles including within the release agent, and the like, is performed with assembling, an aggregation, and a fusion in the aqueous medium, so that aggregated particles are formed. In these aggregated particles, a domain of the crystalline polyester resin including within the release agent exists in the matrix of the noncrystalline polyester resin, respectively.

The aggregated particles are preferably formed by adding a salting-out agent comprising a metallic salt as an aggregation agent into the dispersion liquid of the noncrystalline polyester resin, having a concentration not lower than the critical aggregation concentration, at a room temperature, while the combined dispersion liquid is agitated by a rotation shearing type homogenizer. The aggregation is preferably performed at the same time as the salting-out being in process, in which the combined dispersion liquid is heated at a temperature which is not lower than the glass transition temperature of the binder-resin, and is not lower than the melting point peak temperature (° C.) of the binder-resin and the coloring agent. Here, as the salting-out agent, lithium; potassium; and sodium can be cited as a monovalent metallic salt, and magnesium; calcium; strontium; and barium can be cited as a bivalent metallic salt. The salting-out agent is preferably potassium, sodium, magnesium, calcium, and barium.

The aggregation and the fusion (the blending) of the noncrystalline polyester resin dispersion liquid, the coloring agent dispersion liquid, and the dispersion liquid of the crystalline polyester resin including within the release agent are preferably performed at the same time so that the particles are grown to a desired particle diameter, in terms of the production stability. Incidentally, the aggregation may be completed at a temperature which is approximately the glass transition point of the noncrystalline polyester resin±10° C., and then the fusion (the blending) step may subsequently be performed.

When the aggregated particles reach the desired particle diameter of for example, 4.5-7.5 μm, it is preferable to add an aggregation stopping agent so that the aggregated particles are fixed to the desired toner particle diameter. The aggregation stopping agent is referred to as a compound which eliminates or considerably diminishes the salting-out performance, that is to say, the aggregation field of the polyester resin particles, by the metallic salt used in the aggregation step.

The compounds described by the following formulae are preferable exemplified compounds which may be used as the aggregation stopping agent. The particularly preferable compounds to be used are the ones described by the following formulae (2-1) and (2-2).

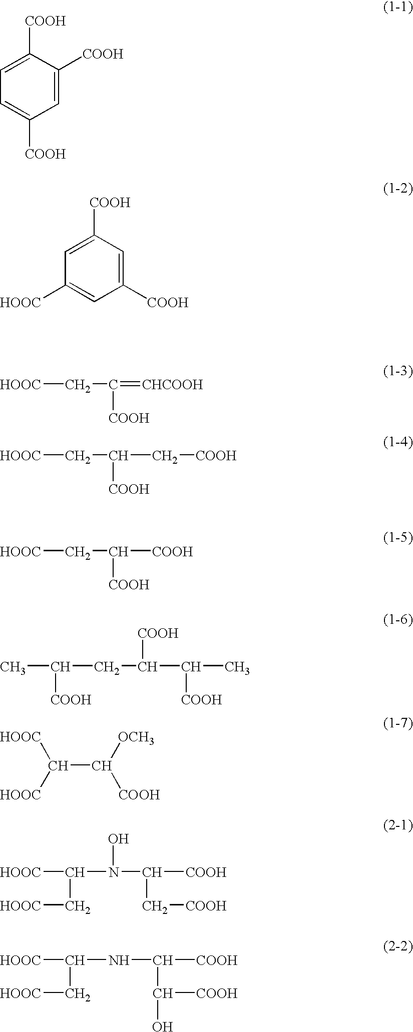

Other than the ones described above, inorganic sodium salt, sodium sulfate, hydrogen sulfate, and sodium phosphate may also be used as the aggregation stopping agent. Sodium chloride is particularly preferable in that the particle diameter can be controlled with a high controllability.

When bivalent metallic ion is used as the aggregation agent, polycarboxylic acid is preferably used as the aggregation stopping agent. The polycarboxylic acid is referred to as a compound comprising two or more carboxylic groups in one molecule. The polycarboxylic acid comprising 12 or less number of carbon atoms is particularly preferable. The polycarboxylic acid is bonded with the bivalent metallic ion on a priority basis, thereby the salting-out can be diminished by the addition of the polycarboxylic acid. The additive amount of the polycarboxylic acid is preferably not less than an equimolar amount of the bivalent metallic ion. However, the polycarboxylic acid may alternatively be added with less than the equimolar amount so that the aggregation speed of the polyester resin particles be diminished. Among the polycarboxylic acid compounds, iminocarboxylic acid is particularly preferable. To put it concretely, the especially preferable compound is the above described exemplified compound (2-2).

In the above mentioned aggregation steps, first, various types of dispersion liquids to be used in these aggregation steps are combined at a predetermined proportion so as to prepare the combined dispersion liquid. The various types of dispersion liquid include, at least, the dispersion liquid of the noncrystalline polyester resin, the dispersion liquid of the coloring agent, and the dispersion liquid of the crystalline polyester resin and of the release agent. Other dispersion liquid, such as a charge control agent, besides the above dispersion liquids may also be combined as necessary. When these dispersion liquids are combined so that the combined dispersion liquid is prepared, the amount of the crystalline polyester resin including within the release agent with respect to the toner, regarding the entire solid content in the combined dispersion liquid, is preferably 4-40% by mass, and more preferably 6-30% by mass. In the particles of the crystalline polyester resin including within the release agent, the release agent is preferably included by 10-50% by mass, and more preferably included by 15-40% by mass. Further, the included amount of the release agent with respect to the entire solid content in the combined dispersion liquid is preferably 2-20% by mass, and more preferably 4-12% by mass. Each of the dispersion liquid may be added and combined at the same time, or alternatively, separately in multiple stages, respectively.

3. Circularity Degree Adjusting Step

This step is a shape controlling step to adjust the circularity degree of the aggregated particles.

The aggregation stopping agent is added to stop the growth of the particle diameter in the above mentioned aggregation stopping step, and the agitating and the combining are continued at a temperature which is not lower than the glass transition point and not higher than 97° C., and preferably in the range of 54-65° C. When the circularity degree of the aggregated particles reaches the desired value, the system is cooled down so that the reaction is fixed. The circularity degree of the aggregated particles is increased, that is to say, a spheronization is to be in progress over time, is estimated to be because the viscosity and the surface tensity caused by the resin property of the aggregated particles reduce the surface area thereof.

By this step, the circularity degree of the aggregated particles is adjusted, and the toner particles are obtained. Thereby, the particle distribution of the toner particles can be further sharpened, so that the toner particle surface can be controlled so as to be smooth and have a uniform shape. The circularity degree is preferably in the range of 0.920-0.975, in terms of the filming-resistant property. The circularity degree is measured by “FPIA2100” (manufactured by Sysmex Corporation).

4. Solid-Liquid Separation/Drying Step

This step is to separate the toner particles from the aqueous medium and to dry the separated toner particles.

The dispersion liquid of the toner particles which have been obtained by the circularity degree adjusting step is cooled down, and is subjected to a solid-liquid separation so as to obtain a toner cake (which is a cake-shaped lump made by aggregating wet toner particles). Subsequently, the toner cake is subjected to washing processing and filtration processing to remove the added substances such as the surface activating agent, the salting-out agent, and the like, therefrom. The filtration processing may be performed by a centrifugal separation method, a decompression filtration method using a funnel, a filtration method using a filter press, and the like, although the method of the filtration is not particularly limited.

Subsequently, the toner cake which is obtained by the washing and the filtration is subjected to the drying processing. As the drying machine to be used in this drying processing, a spray dryer, a vacuum freeze dryer, and a decompression dryer can be cited. Further, the drying machine is preferably either a static shelf-type dryer, a movable shelf-type dryer, a layer flowing dryer, a tumbler dryer, or an agitating-type dryer.

5. Outer Additive Agent Combining Step

Although this step is not necessarily required in the manufacturing method according to the embodiment of the present invention, it is preferable to combine an outer additive agent to adhere or fix the outer additive agent on the toner particle surface in terms of improving the filming-resistant property.

The outer additive processing may be performed by using a known combining machine such as, for example, a V-type blender, Henschel mixer, and Ledige mixer, so that the outer additive agent is gradually attached to the toner particle surface.

### Example

Hereinbelow, concrete examples according to the embodiment of the present invention are described, although the present invention is not limited to the described examples.

Toners O1-O4, P1-P4, Q1-Q4, and R1-R4 according to the example, and toners S1-S4 and T1-T4 according to a comparative example are respectively prepared. A developer is prepared by using each toner, and evaluation experiments are performed by using the prepared developer.

1. Preparation of Various Dispersion Liquids

(1.1) Making the Dispersion Liquid of Noncrystalline Polyester Resin 1

Compounds A group of the following composition and 0.12 by mass of dibutyltin oxide as a catalyst are put into a three-necked flask which is heated and dried. Then, the air inside the container is decompressed by a decompression operation, made into an inert atmosphere by nitrogen gas, and the compounds are subjected to reflux processing by a machine agitation at 180° C. for six hours. Subsequently, the compounds are subjected to agitation processing for five hours while the temperature is gradually raised to 200° C. by distillation under reduced pressure, and are performed with a molecular weight measurement by the GPC when the compounds are in a viscous state. When the weight average molecular weight is 13700, the distillation under reduced pressure is stopped to cool down the air, and thus the noncrystalline polyester resin 1 is prepared. Incidentally, the glass transition temperature of the noncrystalline polyester resin 1 is 63.0° C.

### [Compounds A Group]

bisphenol A propylene oxide adduct (average number of additive mole 2): 140 by mass

bisphenol A ethylene oxide adduct (average number of additive mole 2): 60 by mass

dimethyl isophthalate: 40 by mass

terephthalic acid: 70 by mass

Subsequently, the noncrystalline polyester resin 1 which is still in the molten state is transferred to “Cavitron CD1010” (manufactured by Eurotec Ltd.) at a speed of 100 g per minute. On the other hand, diluted ammonia water which is prepared by diluting reagent ammonia water by ion-exchanged water so as to be a concentration of 0.37% by mass is put into an aqueous medium tank which has been separately prepared, and is heated to 120° C. by a heat exchanger. Then the diluted ammonia water which has been heated is transferred to the Cavitron CD1010 at the same time as the noncrystalline polyester resin 1. The transferring speed thereof is 0.1 liter per minute. In this state, the Cavitron CD1010 is driven under the condition in which the rotation frequency of the rotor is 60 Hz and the pressure is 4.9×10⁵ Pa, thereby the dispersion liquid of the noncrystalline polyester resin 1 having a median diameter on a volumetric basis of 0.28 μm is prepared. Subsequently, the water amount of the dispersion liquid is adjusted so that the resin particle concentration of the noncrystalline polyester resin is to be 20% by mass.

(1.2) Making the Dispersion Liquid of Noncrystalline Polyester Resin 2

A noncrystalline polyester resin 2 is made under the same condition as described above other than the compound A group used in the process of making the noncrystalline polyester resin 1 being replaced to the following compound B group. The weight average molecular weight of the made noncrystalline polyester resin 2 is 18100, and the glass transition temperature is 59.6° C.

### [Compounds B Group]

bisphenol A propylene oxide adduct (average number of additive mole 2): 140 by mass

bisphenol A ethylene oxide adduct (average number of additive mole 2): 70 by mass

dimethyl isophthalate: 30 by mass

terephthalic acid: 50 by mass

dodecenylsuccinic acid: 50 by mass

The noncrystalline polyester resin 2 is performed with an emulsification and dispersion processing by the Cavitron CD1010 under the same condition applied in making the dispersion liquid of the noncrystalline polyester resin 1, thereby the dispersion liquid of the noncrystalline polyester resin 2 having the median diameter on a volumetric basis of 0.14 μm is prepared. Further, the water amount of the dispersion liquid is adjusted so that the resin particle concentration of the noncrystalline polyester resin is to be 20% by mass.

(1.3) Making the Dispersion Liquid of Crystalline Polyester Resin 1 Including within the Release Agent

Compounds C group of the following composition is put into a three-necked flask which is heated and dried. Further, tetra butoxy titanium (Ti(OBu)₄) of an amount of 0.014% by mass with respect to sebacic acid is also put therein as a catalyst. Then, the air inside the flask container is decompressed by a decompression operation, made into an inert atmosphere by nitrogen gas, and the compounds are subjected to reflux processing by a machine agitation at 180° C. for five hours. Subsequently, the compounds are subjected to agitation processing for three hours while the temperature is gradually raised to 200° C. by distillation under reduced pressure, and are performed with a molecular weight measurement by the GPC when the compounds are in a viscous state. When the weight average molecular weight is 15000, the distillation under reduced pressure is stopped to cool down the air, and thus the crystalline polyester resin 1 is prepared.

### [Compounds C Group]

sebacic acid: 200 by mass

1,6-hexane diol: 120 by mass

Subsequently, pentaerythritol tetrabehenate is added by 160 by mass as the release agent, and the crystalline polyester resin 1 which is still in the molten state is transferred to the Cavitron CD1010 at a speed of 100 g per minute. On the other hand, diluted ammonia water which is prepared by diluting reagent ammonia water by ion-exchanged water so as to be a concentration of 0.37% by mass is put into an aqueous medium tank which has been separately prepared, and is heated to 120° C. by a heat exchanger. Then the diluted ammonia water which has been heated is transferred to the Cavitron CD1010 at the same time as the melt crystalline polyester resin 1 at the speed of 0.1 liter per minute. In this state, the Cavitron CD1010 is driven under the condition in which the rotation frequency of the rotor is 60 Hz and the pressure is 4.9×10⁵ Pa, thereby the dispersion liquid of the crystalline resin 1 including within the release agent is prepared. Incidentally, the median diameter on a volumetric basis of the crystalline polyester resin 1 including within the release agent is 0.26 μm. Further, the water amount of the dispersion liquid is adjusted so that the resin particle concentration thereof is to be 20% by mass.

(1.4) Making the Dispersion Liquid of Crystalline Polyester Resin 2 Including within the Release Agent

A crystalline polyester resin 2 including within the release agent is made under the same condition as described above other than the compound C group used in the process of making the crystalline polyester resin 1 including within the release agent, being replaced to the following compound D group, and 160 by mass of pentaerythritol tetrabehenate being replaced to 160 by mass of paraffine wax (having a melting point of 90° C.) as the release agent. The weight average molecular weight of the made crystalline polyester resin 2 including within the release agent is 18500.

### [Compounds D Group]

1,10-dodecanedioic acid: 200 by mass

nonane diol: 140 by mass

The crystalline polyester resin 2 is performed with an emulsification and dispersion processing by the Cavitron CD1010 under the same condition applied in making the dispersion liquid of the crystalline polyester resin 1 including within the release agent, thereby the dispersion liquid of the crystalline polyester resin 2 including within the release agent, having the median diameter on a volumetric basis of 0.23 μm is prepared. Further, the water amount of the dispersion liquid is adjusted so that the resin particle concentration thereof is to be 20% by mass.

(1.5) Making the Dispersion Liquid of Crystalline Polyester Resin 3 Including within the Release Agent

A dispersion liquid of a crystalline polyester resin 3 including within the release agent is made under the same condition as described above in the process of making the dispersion liquid of the crystalline polyester resin 1 including within the release agent, other than the pentaerythritol tetrabehenate being replaced to behenyl behenate.

(1.6) Making the Dispersion Liquid of Crystalline Polyester Resin 4 Including within the Release Agent

A dispersion liquid of a crystalline polyester resin 4 including within the release agent is made under the same condition as described above in the process of making the dispersion liquid of the crystalline polyester resin 2 including within the release agent, other than the paraffin wax being replaced to glycerin tribehenate.

(1.7) Preparation of Cyan Coloring Agent Dispersion Liquid C

C.I. pigment blue (15:3): 50 by mass

ionic surface activating agent (n-sodium dodecylbenzenesulfonate): 8 by mass

ion-exchanged water: 250 by mass

The above described components are combined and dissolved, subjected to the dispersion processing for 10 minutes by a homogenizer “Ultra-Turrax T50” (manufactured by IRA) and processing for 20 minutes by an ultrasonic dispersion machine. Thus, the dispersion liquid C of the cyan coloring agent in which the coloring agent particles having the median diameter on a volumetric basis of 180 nm are dispersed is prepared.

(1.8) Preparation of Magenta Coloring Agent Dispersion Liquid M

C.I. pigment red 122: 30 by mass

C.I. pigment red 238: 20 by mass

ionic surface activating agent (n-sodium dodecylbenzenesulfonate): 8 by mass

ion-exchanged water: 250 by mass

The above described components are combined and dissolved, subjected to the dispersion processing for 10 minutes by the above mentioned Ultra-Turrax T50 and processing for 20 minutes by the ultrasonic dispersion machine. Thus, the dispersion liquid M of the magenta coloring agent in which the coloring agent particles having the median diameter on a volumetric basis of 210 nm are dispersed is prepared.

(1.9) Preparation of Yellow Coloring Agent Dispersion Liquid Y

C.I. pigment yellow 74: 50 by mass

ionic surface activating agent (n-sodium dodecylbenzenesulfonate): 8 by mass

ion-exchanged water: 250 by mass

The above described components are combined and dissolved, subjected to the dispersion processing for 10 minutes by the above mentioned Ultra-Turrax T50 and processing for 20 minutes by the ultrasonic dispersion machine. Thus, the dispersion liquid Y of the yellow coloring agent in which the coloring agent particles having the median diameter on a volumetric basis of 250 nm are dispersed is prepared.

(1.10) Preparation of Black Coloring Agent Dispersion Liquid K

carbon black “Regal 330” (manufactured by Cabot Corporation): 10 by mass

C.I. pigment blue (15:3): 40 by mass

ionic surface activating agent (n-sodium dodecylbenzenesulfonate): 8 by mass

ion-exchanged water: 250 by mass

The above described components are combined and dissolved, subjected to the dispersion processing for 10 minutes by the above mentioned Ultra-Turrax T50 and processing for 20 minutes by the ultrasonic dispersion machine. Thus, the dispersion liquid K of the black coloring agent in which the coloring agent particles having the median diameter on a volumetric basis of 310 nm are dispersed is prepared.

(2.1) Making a Dispersion Liquid of Crystalline Polyester Resin 1 for Comparison

A dispersion liquid of a crystalline polyester resin 1 for comparison is made under the same condition as described above in the process of making the dispersion liquid of the crystalline polyester resin 1 including within the release agent, other than the 160 by mass of the pentaerythritol tetrabehenate as the release agent not being included. The median diameter on a volumetric basis is 0.21 μm.

(2.2) Making a Dispersion Liquid of Crystalline Polyester Resin 2 for Comparison

A dispersion liquid of a crystalline polyester resin 2 for comparison is made under the same condition as described above in the process of making the dispersion liquid of the crystalline polyester resin 2 including within the release agent, other than the 160 by mass of the paraffin wax as the release agent not being included.

(2.3) Making a Release Agent Dispersion Liquid 1 for Comparison

pentaerythritol tetrabehenate: 160 by mass

ionic surface activating agent (i-sodium dodecylbenzenesulfonate): 5 by mass

ion-exchanged water: 200 by mass

The above described components are combined, dissolved, and heated to 95° C. Then, the solution is subjected to the dispersion processing for 10 minutes by the above mentioned Ultra-Turrax T50 and further dispersion processing by the pressure discharge-type Gaulin homogenizer, thus the release agent dispersion liquid 1 for comparison is prepared. The median diameter on a volumetric basis of the release agent particles of the release agent dispersion liquid 1 for comparison is 220 nm.

(2.4) Making a Release Agent Dispersion Liquid 2 for Comparison

A release agent dispersion liquid 2 for comparison is made under the same condition as described above in the process of making the release agent dispersion liquid 1 for comparison, other than the pentaerythritol tetrabehenate being replaced to a paraffin wax “FNP0090”. The median diameter on a volumetric basis of the made release agent dispersion liquid 2 for comparison is 210 nm.

2. Making the Toner and the Developer

(1.1) Making the Toner O1

the dispersion liquid of the noncrystalline polyester resin 1: 560 by mass

the dispersion liquid of the crystalline polyester resin 1 including within the release agent: 340 by mass the cyan coloring agent dispersion liquid C: 80 by mass

The above described components are put into a round-bottomed stainless flask, and are agitated with 300 by mass of ion-exchanged water so as to be 20° C. Subsequently, the compound liquid is sufficiently combined and performed with the dispersion processing by the Ultra-Turrax T50 so that the dispersion liquid is prepared. Subsequently, 0.1 by mass of polyalminum chloride is added into the dispersion liquid, and the dispersion processing is continued by the Ultra-Turrax T50. After the dispersion processing, the flask is put into oil-bath for heating, and the flask is heated to 45° C. while being agitated. The flask is kept at 45° C. for 60 minutes, and then 200 by mass of the dispersion liquid of the noncrystalline polyester resin 1 is gradually added therein.

Further, the exemplified compound described by the formula (2-1) is added by the amount of 1% of the dispersion liquid solid content, and the system is adjusted to pH 8 by 0.5 mol/liter of sodium hydroxide solution. Subsequently, the stainless flask is sealed by a magnetic seal and is continued with the agitation until the content thereof is heated to 90° C., then the system is adjusted to pH 7 by 0.5 mol/liter of nitric acid and is kept for 30 minutes to continue the reaction.

After the reaction is finished, by using a multitubular heat exchanger (in which the refrigerant is cold water of 5° C.), the flow amount of the cold water is adjusted to a cooling speed of −25° C./minute so that the content therein is immediately cooled down to 30° C. Then, filtration processing is performed followed by the sufficient washing by the ionic-exchanged water, and funnel type suction filtration to perform solid-liquid separation. Further, the separated particles are dispersed again in 3 liters of ionic-exchanged water of 43° C., and are performed with agitation for 15 minutes under the condition of 300 rpm, followed by washing processing.

The above mentioned operation is repeated for 5 times until the filtrate has pH 6.6 and an electric conductivity of 12 μS/cm, and then the solid-liquid separation is performed by using the filter paper of No5A by the funnel type suction filtration. Subsequently, vacuum drying is continued for 12 hours, and thus the toner O1 of cyan is made. The median diameter on a volumetric basis of the toner particles is 6.5 μm.

(1.2) Making the Toners O2-O4

The toner O2 of the magenta color is made through the same procedure as described above in making the toner O1, other than the cyan coloring agent dispersion liquid C being replaced to the magenta coloring agent dispersion liquid M. The median diameter on a volumetric basis of the toner particles is 6.5 μm.

Further, the toner O3 of yellow is made through the same procedure as described above other than the cyan coloring agent dispersion liquid C being replaced to the yellow coloring agent dispersion liquid Y. The median diameter on a volumetric basis of the toner particles is 6.3 μm.

Further, the toner O4 of black is made through the same procedure as described above other than the cyan coloring agent dispersion liquid C being replaced to the black coloring agent dispersion liquid K. The median diameter on a volumetric basis of the toner particles is 6.5 μm.

(1.3) Making the Toner P1

the dispersion liquid of the noncrystalline polyester resin 2: 500 by mass

the dispersion liquid of the crystalline polyester resin 2 including within the release agent: 300 by mass

the cyan coloring agent dispersion liquid C: 70 by mass

The above described components are put into a round-bottomed stainless flask, and are agitated with 500 by mass of ion-exchanged water so as to be 20° C. Subsequently, the flask is put into oil-bath for heating, and 0.5 by mass of polyaluminum chloride is added therein while being performed with the dispersion processing by the Ultra-Turrax T50. Then, the flask is heated to 45° C., kept for 50 minutes, and 250 by mass of the dispersion liquid of the noncrystalline polyester resin 2 is added therein and is kept for 30 minutes.

Further, the exemplified compound described by the formula (2-1) is added by the amount of 1.2% of the dispersion liquid solid content, and the system is adjusted to pH 8.0 by 0.5 mol/liter of sodium hydroxide solution. The subsequent processing is performed through the same procedure as described above in making the toner O1, thereby the toner P1 having the median diameter on a volumetric basis of 6.4 μm is made.

(1.4) Making the Toners P2-P4

The toner P2 of magenta is made through the same procedure as described above in making the toner P1, other than the cyan coloring agent dispersion liquid C being replaced to the magenta coloring agent dispersion liquid M. The median diameter on a volumetric basis of the toner particles is 6.4 μm.

Further, the toner P3 of yellow is made through the same procedure as described above in making the toner P1, other than the cyan coloring agent dispersion liquid C being replaced to the yellow coloring agent dispersion liquid Y. The median diameter on a volumetric basis of the toner particles is 6.5 μm.

Further, the toner 24 of black is made through the same procedure as described above in making the toner P1, other than the cyan coloring agent dispersion liquid C being replaced to the black coloring agent dispersion liquid K. The median diameter on a volumetric basis of the toner particles is 6.4 μm.

(1.5) Making the Toners Q1-Q4

The toner Q1 of cyan, the toner Q2 of magenta, the toner Q3 of yellow, the toner Q4 of black are respectively made through the same procedure as described above in making the toners O1-O4, other than the dispersion liquid of the crystalline polyester resin 1 including within the release agent being replaced to the dispersion liquid of the crystalline polyester resin 3 including within the release agent. The median diameter on a volumetric basis of the toner particles is 6.4 μm in toner Q1, 6.3 μm in toner Q2, 6.5 μm in toner Q3, and 6.4 μm in toner Q4, respectively.

(1.6) Making the Toners R1-R4

The toner R1 of cyan, the toner R2 of magenta, the toner R3 of yellow, the toner R4 of black are respectively made through the same procedure as described above in making the toners P1-P4, other than the dispersion liquid of the crystalline polyester resin 2 including within the release agent being replaced to the dispersion liquid of the crystalline polyester resin 4 including within the release agent. The median diameter on a volumetric basis of the toner particles is 6.4 μm in toner R1, 6.3 μm in toner R2, 6.5 μm in toner R3, and 6.4 μm in toner R4, respectively.

(2.1) Making Toner S1 for Comparison

The toner S1 is made through the same procedure as described above in making the toner O1, other than 340 by mass of the dispersion liquid of the crystalline polyester resin 1 including within the release agent being replaced to the following composition.

the dispersion liquid of the noncrystalline polyester resin 1: 560 by mass

the dispersion liquid of the crystalline polyester resin 1 for comparison: 240 by mass

the cyan coloring agent dispersion liquid C: 80 by mass

the release agent dispersion liquid 1 for comparison: 100 by mass

(2.2) Making the Toners S2-S4 for Comparison

The toner S2 for comparison of magenta is made through the same procedure as described above in making the toner S1 for comparison, other than the cyan coloring agent dispersion liquid C being replaced to the magenta coloring agent dispersion liquid M. The median diameter on a volumetric basis of the toner particles is 6.5 μm.

Further, the toner S3 for comparison of yellow is made through the same procedure as described above, other than the cyan coloring agent dispersion liquid C being replaced to the yellow coloring agent dispersion liquid Y. The median diameter on a volumetric basis of the toner particles is 6.3 μm.

Further, the toner S4 for comparison of black is made through the same procedure as described above, other than the cyan coloring agent dispersion liquid C being replaced to the black coloring agent dispersion liquid K. The median diameter on a volumetric basis of the toner particles is 6.4 μm.

(2.3) Making Toner T1 for Comparison

The toner T1 for comparison is made through the same procedure as described above in making the toner 21, other than 300 by mass of the dispersion liquid of the crystalline polyester resin 2 including within the release agent being replaced to the following composition.

the dispersion liquid of the noncrystalline polyester resin 2: 500 by mass

the dispersion liquid of the crystalline polyester resin 2 for comparison: 200 by mass

the cyan coloring agent dispersion liquid C: 70 by mass

the release agent dispersion liquid 2 for comparison: 85 by mass

(2.4) Making the Toners T2-T4 for Comparison

The toner T2 for comparison of magenta is made through the same procedure as described above in making the toner T1 for comparison, other than the cyan coloring agent dispersion liquid C being replaced to the magenta coloring agent dispersion liquid M. The median diameter on a volumetric basis of the toner particles is 6.6 μm.

Further, the toner T3 for comparison of yellow is made through the same procedure as described above, other than the cyan coloring agent dispersion liquid C being replaced to the yellow coloring agent dispersion liquid Y. The median diameter on a volumetric basis of the toner particles is 6.5 μm.

Further, the toner T4 for comparison of black is made through the same procedure as described above, other than the cyan coloring agent dispersion liquid C being replaced to the black coloring agent dispersion liquid K. The median diameter on a volumetric basis of the toner particles is 6.6 μm.

(3) Adding the Outer Additive Agent

Outer additive processing is performed for the made toners O1-O4, P1-P4, Q1-Q4, R1-R4, and the toners for comparison S1-S4, and T1-T4, respectively.

In the outer additive processing, the following outer additive agents are added to 100 by mass of each toner, and combining processing is performed for 10 minutes by 5 L Henschel mixer (which is manufactured by MitsuiMiike Kakoki). Further, a sifting is performed by a wind-power sifter “Highbolter NR-300” (which is manufactured by Tokyo Machinery) with a mesh opening of 45 μm.

cerium oxide particles (the median diameter on a volumetric basis of which is 0.55 μm): 2.5 by mass

titanium oxide particles (having been performed with dodecyltrimethoxysilane processing, and the median diameter on a volumetric basis of which is 30 nm): 0.8 by mass

silica particles (having been performed with hexamethyldisilazane processing, and the median diameter on a volumetric basis of which is 100 nm): 1.2 by mass

(4) Making the Developer

Next, in order to make the developer, 0.8% by mass of silicone resin “SR2411” (which is manufactured by Toray Dow Corning Silicone Co. Ltd.) in mass ratio with respect to ferrite core having a particle diameter of 35 μm is added, followed by coating processing by a kneader apparatus to prepare a carrier.

The toners O1-O4, P1-P4, Q1-Q4, R1-R4, and the toners for comparison S1-S4, and T1-T4, which have been subjected to the outer additive processing, are respectively performed with combining processing with the prepared carrier, to prepare a binary developer for each toner. The composition amount comprises 7 by mass of each toner, and 93 by mass of the prepared carrier, and a V-type blender is used for the combining processing.

3. Evaluation Experiment

Sets of developers comprising the prepared 4 colors of developers of yellow, magenta, cyan and black (a set of the toners O1-O4, a set of the toners P1-P4, a set of the toners Q1-Q4, a set of the toners R1-R4, a set of the toners S1-S4 for comparison, and a set of the toners T1-T4 for comparison) are loaded to an image forming apparatus, so as to perform the following evaluation.

(1) Low-Temperature Fixing Property Evaluation

A full-color printer which is commercially available “bizhub Pro C500” (manufactured by Konica Minolta Business Technologies Inc.) is set to a processing speed of 140 nm/sec, and a fixing test is performed under the fixing temperature being changed in the range of 80-180° C. The lowest temperature of the fixing temperature (the lowest fixing temperature) at which an offset is not generated in either of the toner images of yellow, magenta, cyan and black, is obtained, and the evaluation is performed by the following standard.

Excellent: the lowest fixing temperature is lower than 100° C.

Good: the lowest fixing temperature is 100° C. or higher, and lower than 110° C.

Practicable: the lowest fixing temperature is 110° C. or higher, and lower than 120° C.

Not good: the lowest fixing temperature is 120° C. or higher

(2) Evaluation of the Fixing Intensity

The fixing temperature is fixed to 120° C., and the fixing intensity at the fold line of a sheet in which toner images are performed with the fixing processing is measured in the following manner. The fixing intensity is referred to as the proportion of the toner to be peeled off at a folded part when a sheet performed with the fixing processing is folded, which is indicated as the fixing ratio. To put it concretely, a solid image (meaning an image which is entirely colored) having the image density of 0.8 is printed, thus the toner image is formed by the printing, and the sheet which is performed with the fixing processing is folded so as to scrub the folded part three times with fingers. Next, the folded sheet is opened, and the folded part thereof is cleaned off three times with JK wiper (manufactured by Crecia Co. Ltd.). The density of the toner image at the folded part is measured by a density measuring scale before and after the sheet is folded, and the fixing intensity is calculated by the following formula using the measured density before and after the sheet is folded.

the fixing intensity(%)=(the density after the sheet is folded)/(the density before the sheet is folded)×100

The calculated fixing intensities are evaluated as the following ranks.

Excellent: 95% or more, and 100% or less

Good: 90% or more, and less than 95%

Practicable: 80% or more, and less than 90%

Not good: less than 80%

(3) Evaluation of the Filming-Resistant Property

A continuous printing test is performed under 33° C. and 81% RH environment. After the continuous printing, the photo conductor or the intermediate transcriptional body in the image forming apparatus is visually observed, so as to obtain the integrated number of printed sheets at which a white noise line (which is a defect in the images) corresponding to the toner filming has begun to be detected in the toner images formed on the sheets.

The integrated number of the printed sheets and the toner images are evaluated as follows.

Excellent: The filming is not generated until the 1 million^{th} sheet.

Good: A smudge is not generated on the photo conductor or the intermediate transcriptional body until the 0.8 million^{th} sheet, and a slight filming occurs on the photo conductor or the intermediate transcriptional body by the 1 million^{th} sheet although no defect in the images is detected.

Not Good: Defects in the images by the filming are detected by the 0.8 million^{th} sheet.

(4) Evaluation of the Production Stability

A total of 21 batches of each toner are manufactured to calculate the standard variation of the median diameter on a volumetric basis, thus an evaluation is performed by the following criteria.

Excellent: standard variation of less than 0.080

Good: standard variation of 0.080 or more, and less than 0.130

Not Good: standard variation of 0.130 or more

4. Evaluation Results

The results according to the evaluation experiment are shown in the following table.

TABLE 1

| | LOW- | | | |
|---|---|---|---|---|
| | TEMPERATURE | FIXING | | |
| | FIXING | INTENSITY | FILMING-RESISTANT | PRODUCTION |
| TONER | PROPERTY(° C.) | (%) | PROPERTY | STABILITY |
| O1 | 100 | 92 | NO FILMING UNTIL 1 | 0.074 |
| | | | MILLION^{TH} SHEET | |
| O2 | 100 | 91 | NO FILMING UNTIL 1 | 0.078 |
| | | | MILLION^{TH} SHEET | |
| O3 | 100 | 92 | NO FILMING UNTIL 1 | 0.071 |
| | | | MILLION^{TH} SHEET | |
| O4 | 100 | 90 | NO FILMING UNTIL 1 | 0.082 |
| | | | MILLION^{TH} SHEET | |
| P1 | 95 | 94 | FILMING BY 0.82 | 0.093 |
| | | | MILLION^{TH} SHEET | |
| P2 | 95 | 93 | FILMING BY 0.82 | 0.089 |
| | | | MILLION^{TH} SHEET | |
| P3 | 95 | 93 | FILMING BY 0.82 | 0.091 |
| | | | MILLION^{TH} SHEET | |
| P4 | 95 | 92 | FILMING BY 0.82 | 0.092 |
| | | | MILLION^{TH} SHEET | |
| Q1 | 100 | 97 | FILMING BY 0.92 | 0.079 |
| | | | MILLION^{TH} SHEET | |
| Q2 | 100 | 96 | FILMING BY 0.89 | 0.081 |
| | | | MILLION^{TH} SHEET | |
| Q3 | 100 | 96 | FILMING BY 0.90 | 0.086 |
| | | | MILLION^{TH} SHEET | |
| Q4 | 100 | 96 | FILMING BY 0.92 | 0.081 |
| | | | MILLION^{TH} SHEET | |
| R1 | 90 | 94 | NO FILMING UNTIL 1 | 0.064 |
| | | | MILLION^{TH} SHEET | |
| R2 | 90 | 94 | NO FILMING UNTIL 1 | 0.068 |
| | | | MILLION^{TH} SHEET | |
| R3 | 90 | 94 | NO FILMING UNTIL 1 | 0.069 |
| | | | MILLION^{TH} SHEET | |
| R4 | 90 | 93 | NO FILMING UNTIL 1 | 0.066 |
| | | | MILLION^{TH} SHEET | |
| S1 FOR | 120 | 75 | FILMING BY 0.25 | 0.192 |
| COMPARISON | | | MILLION^{TH} SHEET | |
| S2 FOR | 120 | 76 | FILMING BY 0.26 | 0.193 |
| COMPARISON | | | MILLION^{TH} SHEET | |
| S3 FOR | 120 | 76 | FILMING BY 0.25 | 0.196 |
| COMPARISON | | | MILLION^{TH} SHEET | |
| S4 FOR | 125 | 73 | FILMING BY 0.26 | 0.201 |
| COMPARISON | | | MILLION^{TH} SHEET | |
| T1 FOR | 120 | 78 | FILMING BY 0.31 | 0.211 |
| COMPARISON | | | MILLION^{TH} SHEET | |
| T2 FOR | 120 | 74 | FILMING BY 0.31 | 0.205 |
| COMPARISON | | | MILLION^{TH} SHEET | |
| T3 FOR | 120 | 75 | 0.30 MILLION^{TH} SHEET | 0.207 |
| COMPARISON | | | | |
| T4 FOR | 125 | 77 | 0.32 MILLION^{TH} SHEET | 0.199 |
| COMPARISON | | | | |

As shown in table 1, the toners O1-O4, P1-P4, Q1-Q4, and R1-R4 according to the embodiment realize the lowest fixing temperatures all of which are 100° C. or lower, showing that the low-temperature fixing property is improved compared to that of the toners S1-S4 and T1-T4 for comparison. Further, the fixing intensity is also high, which is 90% or more.

Moreover, the filming occurs by the continuous printing of approximately 0.3 million sheets in the case of the toners S1-S4 and T1-T4 for comparison, whereas defects in the images do not occur until 0.8 million sheets in the case of the toners O1-O4, P1-P4, Q1-Q4, and R1-R4 according to the embodiment, which shows the superiority in filming-resistant property. The standard variation of the median diameter on a volumetric basis in the case of the toners O1-O4, P1-P4, Q1-Q4, and R1-R4 according to the embodiment is less than 0.0100, which shows less unevenness in particle diameter of the toner particles. That is to say, toners having a sharp particle diameter distribution of the toner particles can be manufactured, thus enabling the stable production thereof.

According to a first aspect of the preferred embodiment of the present invention, there is provided a toner, comprising:

a noncrystalline polyester resin;

a crystalline polyester resin;

a release agent; and

a coloring agent,

wherein the toner has a domain matrix structure in which the matrix comprises the noncrystalline polyester resin and the domain comprises the crystalline polyester resin and the release agent,

and wherein the crystalline polyester resin includes within the release agent.

The domain is a domain in which the crystalline polyester resin includes the release agent therein.

Preferably, the toner, having a core-shell structure which has a core and a shell,

wherein the core has the domain matrix structure in which the matrix comprises the noncrystalline polyester resin and the domain comprises the crystalline polyester resin and the release agent,

and wherein the crystalline polyester resin includes within the release agent.

According to a second aspect of the preferred embodiment of the present invention, there is provided a manufacturing method of a toner, comprising:

aggregating at least a noncrystalline polyester resin, a coloring agent, and a crystalline polyester resin including within a release agent in an aqueous medium.

Preferably, the manufacturing method of the toner further comprises:

preparing a dispersion liquid of particles of the crystalline polyester resin including within the release agent, by heating the release agent and the crystalline polyester resin to a temperature not lower than a melting point of at least either the release agent or the crystalline polyester resin, and performing dispersion processing.

The toner according to the present invention improves the low-temperature fixing property and the fixing intensity of a toner, and provides superiority in filming-resistant property and stability in production thereof.

The hydrophobic property of the noncrystalline polyester resin, the crystalline polyester resin, and the release agent is generally in the order of [the release agent]>[the crystalline polyester resin]>[the noncrystalline polyester resin]. This is due to the length of the hydrocarbon group, and the density of the polar group such as the ester group being low.

As such, the polar difference of the release agent and the noncrystalline polyester resin is large, and the adhesion force between the noncrystalline polyester resin which is to be the binder-resin and the release agent is relatively weak. Accordingly, in a case where the toner particles are crushed by the agitation in the development apparatus, for example, the domain of the release agent is released so as to be release agent particles, thereby the filming is likely to occur in the photo conductor or the intermediate transcriptional body in the image forming apparatus. This is because the release agent particles have a property in that their hardness is low in an ambient temperature, and they tend to be extended by a cleaning blade. However, in a case where the release agent and the crystalline polyester resin blend together, or the release agent is included in the crystalline polyester resin, as in the embodiment of the present invention, the crystalline polyester resin functions as a bond so as to drastically reduce the probability for the release agent to be released.

Further, three types of substances respectively having a different polar character, namely the release agent particles, the crystalline polyester resin particles, and the noncrystalline polyester resin particles, have conventionally been aggregated in view of the production stability. However, the surface design according to the embodiment of the present invention appears to be the aggregation of the crystalline polyester resin particles and the noncrystalline polyester resin particles. Therefore, the aggregation process is stabilized, thereby the unevenness in the structure of the toner particles to be manufactured is conceived to be substantially reduced.

Further, when the molten release agent bleeds out in the adhesion surface between the printing sheet and the toner image, the fixing property has conventionally been reduced. However, in the toner according to the embodiment of the present invention, the release agent and the crystalline polyester resin blend together, or the release agent is included in the crystalline polyester resin, thereby it is conceived that the adhesion force with the sheet, and the fixing intensity will be improved.

The entire disclosure of Japanese Patent Application No. 2008-320972 filed on Dec. 17, 2008, including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A toner, comprising:
a noncrystalline polyester resin;
a crystalline polyester resin;
a release agent; and
a coloring agent,
wherein the toner has a domain matrix structure in which the matrix comprises the noncrystalline polyester resin and the domain comprises the crystalline polyester resin and the release agent,
and wherein the crystalline polyester resin includes within the release agent.

2. The toner as claimed in claim 1, having a core-shell structure which has a core and a shell,
wherein the core has the domain matrix structure in which the matrix comprises the noncrystalline polyester resin and the domain comprises the crystalline polyester resin and the release agent,
and wherein the crystalline polyester resin includes within the release agent.

3. A manufacturing method of a toner, comprising:
aggregating at least a noncrystalline polyester resin, a coloring agent, and a crystalline polyester resin including within a release agent in an aqueous medium.

4. The manufacturing method of the toner as claimed in claim 3, further comprising:
preparing a dispersion liquid of particles of the crystalline polyester resin including within the release agent, by heating the release agent and the crystalline polyester resin to a temperature not lower than a melting point of at least either the release agent or the crystalline polyester resin, and performing dispersion processing.
